(19) United States
(12) Patent Application Publication
(10) Pub. No.: US 2020/0013121 A1
(43) Pub. Date: Jan. 9, 2020

(54) LINKED FINANCIAL VEHICLES FOR MITIGATION OF LOSSES ASSOCIATED WITH REQUIRED MINIMUM DISTRIBUTIONS

(71) Applicant: Omega Results, Inc., Perry, IA (US)

(72) Inventors: RANDY E. TIMM, PERRY, IA (US); JORDAN F. WADDELL, PANORA, IA (US); TIMOTHY PFEIFER, LIBERTYVILLE, IL (US)

(21) Appl. No.: 16/572,258

(22) Filed: Sep. 16, 2019

Related U.S. Application Data
(63) Continuation of application No. 15/249,173, filed on Aug. 26, 2016, now abandoned.
(60) Provisional application No. 62/210,144, filed on Aug. 26, 2015.

(51) Int. Cl. G06Q 40/06; G06Q 40/02

(52) U.S. Cl. CPC G06Q 40/06; G06Q 40/02

(57) ABSTRACT

An improved a financial system and method is directed to preventing leakage of assets associated with required minimum disbursements. The system includes a tax-qualified annuity or investment (“Asset A”) operably linked to a non-tax-qualified annuity or investment (“Asset B”). An automatic annual withdrawal is withdrawn from Asset A, wherein at least a portion of the withdrawal is automatically transferred from Asset A to Asset B. The automatic annual withdrawal can be equal to the required minimum distribution as required by IRS regulations. Asset A and Asset B can be established through the same application process. The system can include enhanced lifetime income benefits, a legacy benefit, and/or an incentive bonus. A consolidated financial statement can be provided, including details from both Asset A and Asset B. The system can be associated with commissions and/or trails based on the consolidated value of Asset A and Asset B.

### CROSS REFERENCE TO RELATED APPLICATION

This application is a continuation of U.S. patent application Ser. No. 15/249,173 filed Aug. 26, 2016, which is a nonprovisional that claims priority from U.S. Provisional Patent Application Ser. No. 62/210,144, filed Aug. 26, 2015, which applications are hereby incorporated by reference in their entireties.

### FIELD OF THE DISCLOSURE

The present disclosure relates generally to protecting assets in retirement. More particularly, but not exclusively, the present disclosure relates to financial systems and methods for preventing leakage due to required minimum distribution rules associated with qualified annuities and/or investments.

### BACKGROUND OF THE DISCLOSURE

Most individuals plan for retirement in some manner and to some extent. In addition to old age benefits administered by the Social Security Administration, numerous financial vehicles exist to prepare for retirement, the most common being an employer-sponsored retirement plan and/or individual retirement arrangements (IRA). In general, the employer-sponsored retirement plan and IRA advantageously do not require an individual pay taxes on interest or growth in the account or IRA during the deposit period (i.e., the contributions are tax deferred). The contributions are generally taxed when an individual takes withdrawals during retirement.

Due to any number of reasons, an individual may have accumulated sufficient wealth to support themselves during retirement. However, based on the tax deferred status of many retirement plan contributions together with average life expectancy, the Internal Revenue Service (IRS) requires an individual begin to make minimum withdrawals from certain retirement plans at a predetermined age. The withdrawals, called Required Minimum Distributions (RMDs) exist, at least in part, for the government to recoup tax revenue deferred during the person's lifetime.

RMDs generally require a retirement plan account owner to make annual withdraws starting with the year that he or she reaches 70½ years of age. The RMD rules apply to all employer-sponsored retirement plans, including profit-sharing plans, 401(k) plans, 403(b) plans, and 457(b) plans. The RMD rules also apply to traditional IRAs and IRA-based plans such as simplified employee pensions (SEPs), salary reduction arrangement simplified employee pensions (SARSEPs), and savings incentive match plan for employee (SIMPLE) IRAs.

IRS Publication No. 590-B lists withdrawal factors for each age year beginning with 70 for a traditional IRA (with additional requirements). An RMD for a particular year is calculated by dividing the year-end account balance by the withdrawal factor. For example, a 75-year-old individual (at year end) has a withdrawal factor of 22.9. An IRA year-end account balance of $100,000 has an RMD of $4,366.81 (4.367%). The RMD is generally taxed at an individual's income tax rate.

However, individuals can face stiff penalties for failure to take RMDs. Specifically, if an account owner fails to withdraw a RMD, fails to withdraw the full amount of the RMD, or fails to withdraw the RMD by the applicable deadline, the amount not withdrawn is taxed at 50%. Each individual retirement plan participant and IRA owner is responsible for taking the correct amount of RMDs on time every year from their accounts. Therefore, a need exists in the art for a financial vehicle that ensures the appropriate RMDs are taken each year consistent with IRS regulations.

As mentioned, an individual may accumulate sufficient wealth over one's lifetime such that it may be undesirable to take RMDs annually. For some, RMDs can escalate the individual into a higher tax bracket and may result in an undesirable taxation of, among other things, Social Security Income. Others may prefer to simply maintain the funds as an inheritance for future generations. Yet IRS regulations require an individual take the RMD each year. Consequently, the withdrawn funds are often underutilized or not utilized whatsoever. Using the above example, the 75-year-old may not need or desire to remove $4,366.81 from his or her traditional IRA. After taking the RMD, however, he or she might simply deposit the RMD into his or her checking and/or savings account, which earns minimal interest relative to other available financial vehicles, including the retirement plan from which the RMD was withdrawn. The difference, known as leakage, undesirably results in loss of assets. Therefore, a further need exists in the art for a financial system and/or method to minimize and preferably eliminate leakage associated with RMDs.

Financially savvy individuals may desire to associate the RMDs with one or more financial vehicles that earn greater returns than checking and/or savings accounts. Yet based on the annual nature of RMDs, the numerous available financial vehicles, and the complexity of RMDs and financial vehicles, an elderly individual might find it burdensome to maintain the accounts in a profitable manner. Therefore, a still further need exists in the art for a financial system and/or method that automatically directs RMDs into other financial vehicles.

### SUMMARY OF THE DISCLOSURE

It is therefore a primary object, feature, and/or advantage of the present disclosure to improve on or overcome the deficiencies in the art.

It is another object, feature, and/or advantage of the present disclosure to provide for a financial vehicle that ensures the appropriate RMDs are taken each year consistent with IRS regulations.

It is yet another object, feature, and/or advantage of the present disclosure to minimize and preferably eliminate leakage associated with RMDs.

It is still yet another object, feature, and/or advantage of the present disclosure to automatically direct RMDs into other financial vehicles. The automation requires less monitoring by the individual and provides peace of mind that the appropriate RMDs are being withdrawn each year.

These and/or other objects, features, and advantages of the present disclosure will be apparent to those skilled in the art. The present disclosure is not to be limited to or by these objects, features and advantages. No single embodiment need provide each and every object, feature, or advantage.

According to an aspect of the disclosure, a financial system for preventing leakage of assets associated with required minimum distributions is provided. The system includes a tax-qualified annuity or investment operably linked to a non-tax-qualified annuity or investment. An automatic annual withdrawal is withdrawn from the tax-qualified annuity or investment, wherein at least a portion of the automatic annual withdrawal can be automatically transferred from the tax-qualified annuity or investment to the non-tax-qualified annuity or investment. The automatic annual withdrawal can be equal to the required minimum distribution as required by Internal Revenue Service regulations.

The tax-qualified annuity or investment and the non-tax-qualified annuity or investment can be established through a same application process. The tax-qualified annuity or investment and/or the non-tax-qualified annuity or investment can be a fixed index annuity. The system can further include a legacy benefit associated with the system. A beneficiary receives the legacy benefit upon death of an asset holder of the financial system.

The system can still further include an incentive bonus associated with the non-tax-qualified annuity or investment. The incentive bonus can comprise a percentage of the non-tax-qualified annuity or investment. The incentive bonus can be deposited into the non-tax-qualified annuity or investment if withdrawals are not taken from the non-tax-qualified annuity.

According to another aspect of the disclosure, a method for preventing leakage of assets associated with required minimum distributions comprises the steps of establishing a tax-qualified annuity or investment and a non-tax-qualified annuity or investment. The tax-qualified annuity or investment account and the non-tax-qualified annuity or investment are operably linked together. The required minimum distribution is withdrawn annually from the tax-qualified annuity or investment in an amount required by Internal Revenue Service regulations. At least a portion of the required minimum distribution can be automatically deposited into the non-tax-qualified annuity or investment. An amount less than the required minimum distribution can be selected to be deposited into the non-tax-qualified annuity or investment.

An incentive bonus can be automatically deposited into the non-tax-qualified annuity. The incentive bonus can be based, at least in part, on whether less than a predetermined amount of withdrawal is made from the non-tax-qualified annuity in a calendar year. The tax-qualified annuity or investment and the non-tax-qualified annuity or investment can be applied for and established simultaneously. A consolidated financial statement can be provided, including details from both the tax-qualified annuity or investment and the non-tax-qualified annuity or investment.

According to another aspect of the disclosure, an option is provided to maximize the potential amount of money that can be taken from an account at the time of the RMD distribution and provides an income floor regardless of future account balance. The highest calculated amount becomes the new guaranteed minimum payment for future years regardless of the balance. Even if the account balance is reducing or is exhausted the annual payment calculated as the substitute for the government calculated RMD will continue until the death of the person or persons' live(s) the payment was initially based on. Each year the client takes a lesser amount than what is available that difference is then recorded and the total of all of those differences could be taken at any time.

### BRIEF DESCRIPTION OF THE DRAWINGS

Illustrated embodiments of the disclosure are described in detail below with reference to the attached figures, which are incorporated by reference herein, and where:

FIG. 1 is a flowchart of a policy process as commonly known in the art;

FIG. 2 is a flowchart of an annuity or investment application process in accordance with an illustrative embodiment;

FIG. 3 is a flowchart of an annuity or investment issue process in accordance with an illustrative embodiment;

FIG. 4 is a flowchart of an annuity or investment disbursement phase in accordance with an illustrative embodiment;

FIG. 5 is a flowchart of an annuity or investment notification process in accordance with an illustrative embodiment; and

FIG. 6 is a schematic diagram of a system with which an exemplary embodiment of the present disclosure can be incorporated.

### DETAILED DESCRIPTION

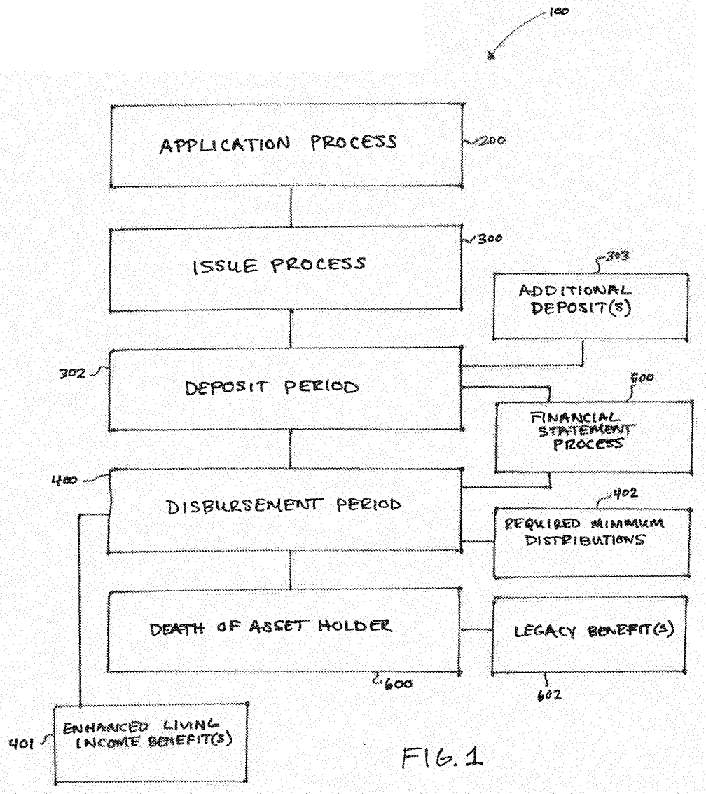

FIG. 1 illustrates a flowchart of a qualified annuity or investment system 100 as commonly known in the art. Hereinafter, “Asset A” refers to a qualified annuity or investment that can include any plan to which IRS regulations related to RMDs apply, including but not limited to employee sponsored plans (profit-sharing plans, 401(k) plans, 403(b) plans, and 457(b) plans) and traditional IRAs and IRA-based SEPs, SARSEPs, SIMPLE IRAs, and the like. In a preferred embodiment, Asset A can include fixed annuities or fixed index annuities. Similarly, hereinafter, “Asset B” refers to a non-qualified annuity or investment that can include any plan in which contributions have already been taxed. In a preferred embodiment, Asset B can include fixed annuities or fixed index annuities.

The process of obtaining a qualified annuity or investment system 100 generally requires a potential asset holder apply through an application process 200. The financial services provider reviews the application. The review process can include evaluation of any number other factors commonly known in the art, including among other things, the suitability of purchasing and owning the asset. Assuming approval, the financial services provider issues Asset A to the asset holder 300.

The issue process may be associated with a minimum deposit into Asset A. The present disclosure contemplates a required minimum deposit can also be associated with the evaluation of the application process 200. The minimum deposit can be associated with a previously established Asset A, from which the funds are rolled over.

Once the asset is established, the policy enters a deposit period 302. The contributions to Asset A during the deposit period 302 are tax deferred. The present disclosure contemplates that the contributions during the deposit period 302 can come from any source. For example, the asset holder may elect to roll over one or more previously established IRAs. For another example, the asset holder may elect to cash out and/or roll over funds associated with one or more other annuities or investments, including but not limited to mutual funds, stocks, bonds, and the like.

The deposit period 302 can also be associated with additional deposits 303. The additional deposits 303 can include supplemental contributions to Asset A in addition to the initial deposit and/or the contributions commonly associated with the deposit period. For example, an asset holder may receive a lump sum of money from the passing of a family member. He or she may choose to deposit the inheritance into Asset B. For another example, an asset holder may receive a tax refund from the IRS and choose to deposit the refund into

Asset B.

Furthermore, while the contributions can be associated with a period prior to retirement of the asset holder, this need not be the case. The contributions and/or additional deposits can occur at any time and when the asset holder is of any age. In a preferred embodiment, however, the deposit period 302 generally terminates with the retirement of the asset holder. In many cases, the asset holder begins collecting disbursements from Asset A, as he or she has purposefully accumulated the policy for this precise purpose. However, as mentioned, an individual may not need (either immediately or at all) to begin taking disbursements from Asset A. If disbursements are taken, they are generally taxed as income at the appropriate income tax rate for the individual.

Regardless of whether disbursements are taken, the disbursement period 400 begins when the asset holder reaches approximately seventy years of age. The disbursement period 400 is associated with RMDs 402. Specifically, for IRAs, an individual must begin taking RMDs 402 by April 1 of the year following the calendar year in which he or she reaches age 70½. For 401(k), profit-sharing, 403(b), or other defined contribution plans, an individual must begin taking RMDs 402 on April 1 following the later of the calendar year in which her or she reaches age 70½ or retires. If the policy is managed by a financial services provider, the asset holder typically receives monthly or yearly statements 500.

The disbursement period 400 can be associated with enhanced living income benefits 401. The enhanced living income benefits 401 provides additional income from Asset A and/or Asset B to the asset holder in response to the presence of specified life circumstances. For example, an asset holder can receive double, triple or any agreed to multiplier of income benefits while receiving long-term care in a nursing home. For another example, an asset holder can receive unencumbered access to the funds within Asset A and/or Asset B if he or she falls terminally ill. In such a situation, no surrender charges can be associated with the ability to withdraw the greater of the amounts permitted by IRS regulations and the issuing company. In addition to income benefits during long-term care and/or terminal illness, the present disclosure contemplates that the enhanced living income benefits 401 can be associated with any number of life and/or other circumstances to assist the asset holder during periods of potential financial or other hardship.

In most cases, the disbursement period 400 continues until the death of the asset holder 600. Depending on, among other things, the type and/or amount of the policy, the policy can be associated with a legacy benefit 602. If other requirements are satisfied, a designated beneficiary can receive the legacy benefit 602. For example, for the year of the account owner's death, RMD is that of what the account owner would have been required to withdraw from Asset A. For the year following the owner's death, the RMD will depend on the identity of the designated beneficiary.

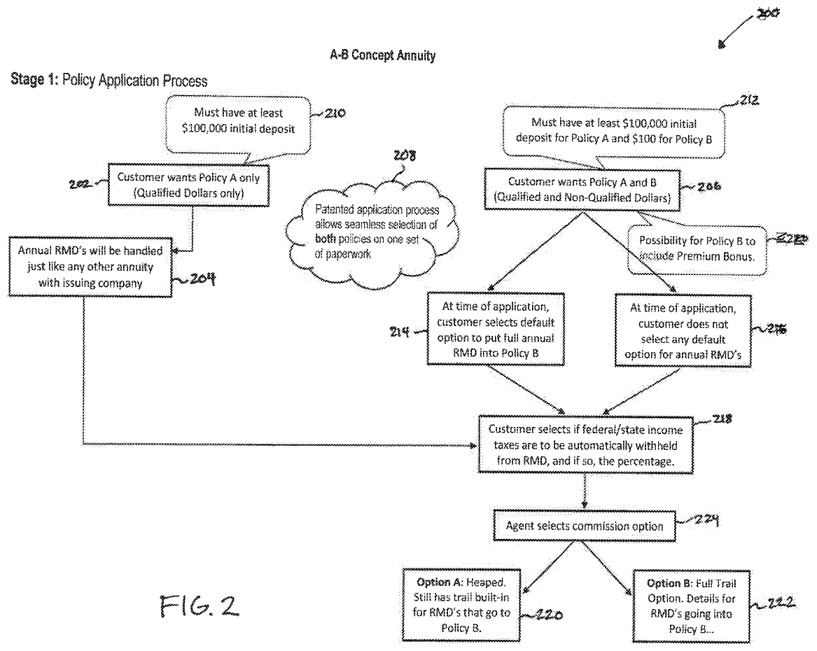

Referring to FIG. 2, if the customer wants only Asset A 202, then the financial services provider (i.e., policy issuing company), will handle the annual RMDs 204 as commonly known in the art. In particular, the issuing company will disburse the RMD to the asset holder on an annual basis and handle all tax-related implications associated with the withdrawal.

If, however, an individual wants to apply for financial system 206 consistent with the objects of the present disclosure, he or she applies for Asset A and Asset B operably linked to Asset A. The linked policies are to prevent leakage of assets associated with RMDs. To do so, the individual can complete a single application process 208 for both policies on one set of paperwork. The single application process 208 eases the administrative burden on both the individual and the issuing company.

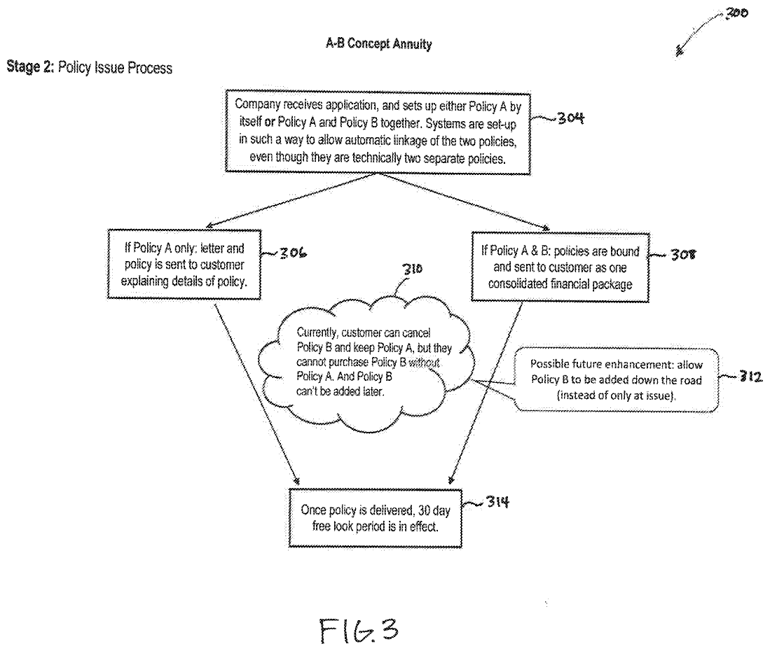

For both Asset A and the linked policies, the issuing company can require a minimum initial deposit 210. The minimum initial deposit can be of any amount appropriate to ensure sufficient growth potential of the policy, sufficient fees for managing the policy, and/or any other number of considerations established by the issuing company. In the illustrated embodiment of FIGS. 2 and 3, the minimum initial deposit 210 is $100,000 for Asset A. The present disclosure contemplates any minimum initial deposit without deviating from the objects of the present disclosure. In instances where the individual applies for a financial system consistent with the objects of the present disclosure, Asset B can also require a minimum initial deposit 212. The minimum initial deposit associated with Asset B can be less than the minimum initial deposit associated with Asset A because, at least in part, a portion of the assets in the tax-qualified policy will be transferred to Asset B. Thus, Asset B will grow over time during the disbursement phase 400, which will be discussed in detail below.

Referring to FIGS. 2 and 3, once the issuing company receives and approves the application, the issuing company generates Asset A or the linked policies 304. Regarding the latter, Asset A and Asset B are arranged in a manner to automatically link the two, despite being two separate policies for various other purposes. In an exemplary embodiment, the two policies are electronically linked, issued, bound and packaged together.

The policy issue process illustrated in FIG. 3 includes sending notification of the newly established policy to the asset holder 306. For the linked policies, the financial statement from Asset A and Asset B are combined into a consolidated financial package 308. The consolidated financial package delivers the information from the linked policies in a manner and format that is helpful to the asset holder.

An asset holder generally establishes Asset A and Asset B at the same time as previously expressed herein 310. The present disclosure contemplates that Asset B can be purchased subsequently to Asset A and linked thereafter 312. Regardless of whether Asset A or linked policies are established, the present disclosure contemplates providing the asset holder with a free trial period 314. In the illustrated embodiment of FIG. 3, the free trial period is thirty days, as is common in the industry.

Referring to FIGS. 2 and 3, the asset holder must select options associated with the linked financial policies 403. Most commonly, the most pertinent option can include the amount of the RMD from Asset A to be deposited into Asset B. In an exemplary embodiment, the amount of the RMD to be deposited into Asset B is selected at the time of the application 403. The present disclosure also contemplates that the asset holder can defer selecting the options at the time of application 216. In instances where the asset holder defers selecting a default option, a letter can be sent to the asset holder annually, preferably in November, listing all available options for handling the RMD the following year 404.

The available options can include: (i) depositing the entire RMD into Asset B 214, 406; (ii) depositing a portion of the RMD into Asset B and taking the remainder as a withdrawal 408; (iii) withdrawing the RMD and depositing none into Asset B 410; or (iv) not taking an RMD from Asset A 412, in which case the RMD must be satisfied from one or more other sources. Regardless of the default option chosen, additional non-qualified money (i.e., taxed) can be deposited into Asset B from other sources 414. For example, an RMD associated with an account other than the tax-qualified account can be deposited into Asset B. If the asset holder selects a default option, the default option is effective for the following calendar year, after which the asset holder can receive correspondence confirming the option for the subsequent calendar year 416. In an exemplary embodiment, the asset holder need not respond to the correspondence unless he or she desires to change the default option.

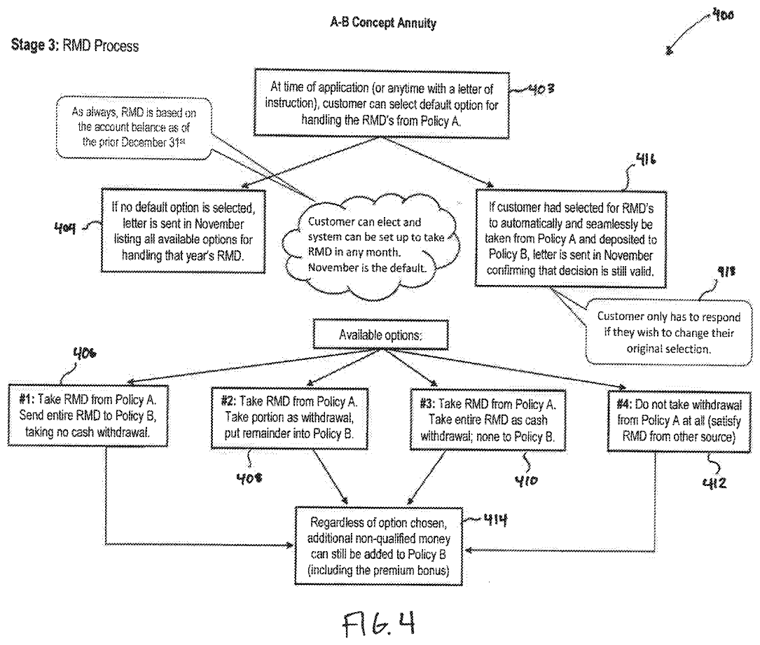

The RMD process of FIG. 4 occurs during the disbursement period 400. In particular, an automatic annual withdrawal is taken from Asset A. At least a portion of the automatic withdrawal is automatically deposited into Asset B. The amount of the portion of the automatic annual withdrawal is based, at least in part, on the default option selected by the asset holder. The amount of the automatic annual withdrawal is at least equal to the RMD as required by IRS regulations.

The RMD, regardless of whether taken as a withdrawal to the asset holder or deposited into Asset B, is taxed. During the application process 200 and/or during the disbursement period 400, an asset holder can select the federal and/or state income taxes to be automatically withheld from the RMD, and if so, the percentage 218.

Asset A can be a qualified fixed index annuity. Similarly, Asset B can be a nonqualified fixed index annuity. In general, fixed index annuities earn a fixed rate of interest guaranteed by the issuing company or an interest rate based on the growth of an external index. The qualified fixed index annuity and the nonqualified fixed index annuity can have identical return rates, surrender charges, and/or caps. Further, the qualified fixed annuity and/or the nonqualified fixed index annuity can be offered for fixed terms. In an exemplary embodiment, the qualified fixed annuity and/or the nonqualified fixed index annuity can comprise seven- and ten-year terms, or other terms as decided by the carrier. The present disclosure contemplates that Asset B can include any type and/or number of alternate financial vehicles including, but not limited to, fixed annuities, variable annuities, mutual funds, money market accounts, certificates of deposit, etc.

The financial system of the present disclosure can be associated with several additional asset holder benefits. For example, the financial system can include a premium bonus comprised of a one-time, up-front deposit into Asset B. Further, the financial system can include incentive bonuses associated with Asset B comprising a percentage of Asset A 220, 414. The incentive bonus can be deposited into Asset A and/or Asset B if no withdrawals (or less than a predetermined amount of withdrawals) are taken from Asset B. In an exemplary embodiment, the incentive bonus can be 4% or any other amount as agreed to by the carrier. The incentive bonus can be automatically deposited annually or consistent with similar arrangements between the issuing company and the asset holder. Further, a long-term care option can be provided. In particular, a waiver and/or rider can be associated with Asset A and/or Asset B to account for the financial burdens of long-term care. Still further, the system 100 can be associated with enhanced living income benefits, including disbursement of additional income during periods of long-term care, terminal illness, and the like, as previously expressed herein. Still yet further, Asset A and/or Asset B can include a “no cap” strategy for accumulating interest in both policies.

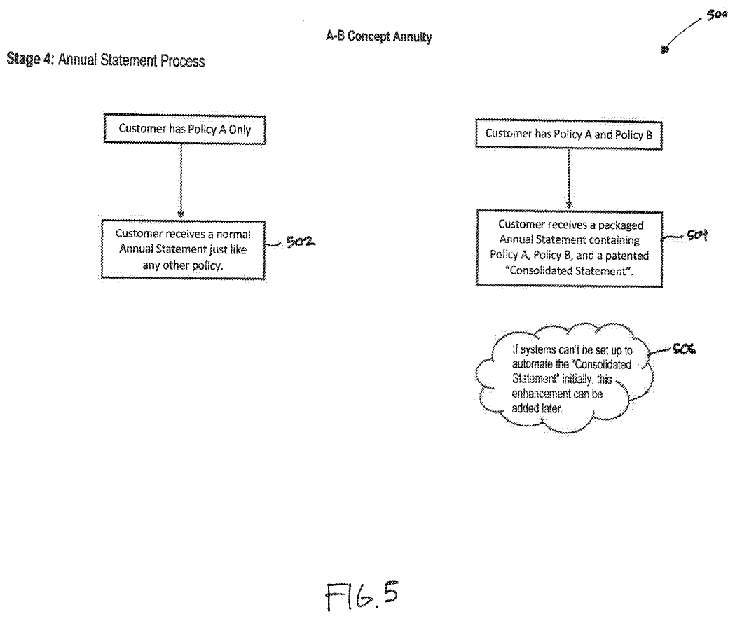

Referring to FIG. 5, a financial statement process 500 is provided. In a preferred embodiment, the asset holder receives an annual statement, but statements can be provided with any frequency (e.g., semiannually, quarterly, etc.) without deviating from the objects of the present disclosure. If the asset holder has only Asset A, the financial statement process 500 comprises receiving an annual statement 502. If the asset holder has the linked policies, the financial statement process 500 can include providing a consolidated statement 504. The consolidated statement provides details, metrics, and the like for both Asset A and Asset B, including but not limited to account balances, deposits, withdrawals, taxed paid, expected taxes, RMD withholding factors, etc.

As mentioned the disbursement period 400 generally ceases with the death of the asset holder 600. Asset A and/or Asset B can be associated with a legacy benefit. Upon the death of the asset holder, a designed beneficiary can receive the legacy benefit. The legacy benefit can be a percentage of the cash balance of Asset A and/or Asset B. The percentage can comply with the IRS entire interest rule and/or comport with other IRS regulations regarding legacy transfer. For example, the legacy benefit can include disbursing 120% of the cash balance of Asset A and/or Asset B over a three- to five-year timeframe. In another exemplary embodiment, the legacy benefit is a system-based calculation (e.g., an interest computation such as compounding interest, etc.) based, at least in part, on the policy rider included within Asset A and/or Asset B.

The financial system 100 of the present disclosure envisions that an advisor can receive a first-year commission on Asset A and a trail commission is built in all years 220 (FIG. 2). Asset B pays the same trail commission for the remainder of the life of the asset holder 222. In an exemplary embodiment, the advisor can select the commission option 224. The advisor also enjoys the benefit of not having to replace or resell the policy, as the policy generally remains active in a fully liquid status until the maturity date (assuming asset holder opts not to cancel the policies). Thus, the administrative burden is minimized on the advisors and carriers as well. The advisors and/or carriers can supplement Asset A with Asset B to avoid RMDs from leaving the advisor and/or carrier.

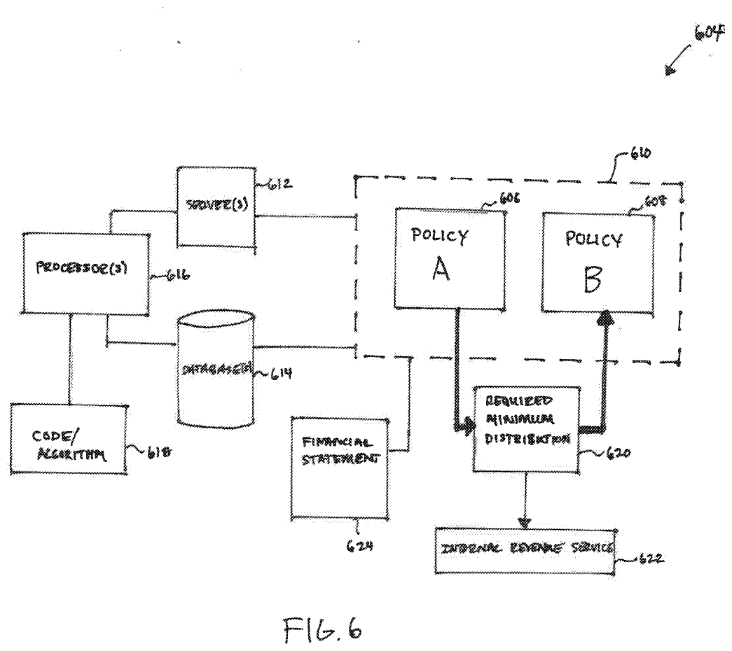

FIG. 6 illustrates an exemplary system 604 with which the objects of the present disclosure can be implemented. Asset A 606 and Asset B 608 are serviced by the same financial services company 610. One or more servers 612 and/or databases 614 are used by the financial services company 610 to administer the system 604. The server(s) 612 and/or the database(s) can be associated with the financial services company 610, as illustrated in FIG. 6, or remotely hosted and/or serviced. One or more processors 616 implement code 618 to perform the operations of the system 604. In particular, the code 618 instructs the processor(s) 616 to withdraw the RMD 620 from Asset A. The RMD is taxed, which is paid to the IRS. At least a portion of the remainder of the RMD is deposited into Asset B 608 consistent with the default option associated with the linked policies. The default option can be stored in the database 614. The financial services company 610 provides statements 624 as previously discussed herein. The statements 624 can include consolidated statements. In instances where an issuing companies systems cannot initially automate the consolidated statement process, the feature can be added at a later date 506 (FIG. 5). The system 604 is also automated to send correspondence every year providing the asset holder the option to change the default option (i.e., what percentage of the RMD is deposited into Asset B). Such automation for the statements 624 and/or the correspondence is contained within the code 618 and processed by the processors 616. The server(s) 612 and/or database(s) 614 also contain information regarding incentive bonuses, legacy benefits, long-term care benefits, advisor commission options, and the like. The system 604 is advantageously designed to be near-automated and/or fully automated to minimize administrative burden on the issuing company.

Another option may be provided to an asset holder as part of the present invention. The option would provide a guaranteed income to the asset holder. Each year when the asset holder takes the RMD, the asset holder would have the choice of receiving the RMD as calculated for that year, or the highest RMD from any prior year, subject to a reduction for any excess withdrawals previously taken. This feature assures that the RMD income of the asset holder never goes down, even if the account value falls. The benefit could be provided in exchange for a rider fee paid by the asset holder, or could be provided free of charge. This feature adds an additional calculation to the annual RMD process that allows the asset holder to take either their IRS calculated RMD or the prior highest RMD amount calculated. It maximizes the potential amount of dollars that can be taken from the account in Asset A at the time of the RMD distribution and provides an income floor regardless of future account balance. The highest calculated amount becomes the new guaranteed minimum payment for future years regardless of the balance in Asset A. Even if the account balance of Asset A is reducing or is exhausted the annual payment calculated as the substitute for the government calculated RMD will continue until the death of the person or persons live(s) the payment was initially based on. The guaranteed minimum income is an optional benefit the client can select or decline each year. Each year the client takes a lesser amount than what is available through the guarantee, that difference is then recorded and the total of all of those differences could be taken at any time.

The disclosure is not to be limited to the particular embodiments described herein. In particular, the disclosure contemplates numerous variations in the type of ways in which embodiments of the disclosure can preventing leakage of assets associated with required minimum distributions. The invention is a novel and nonobvious automated RMD distribution and storage solution that utilizes two policies applied for and issued simultaneously as part of a comprehensive strategy. The invention offers unique RMD storage capability and automated process presenting consolidated values from the two separate policies. The foregoing description has been presented for purposes of illustration and description. It is not intended to be an exhaustive list or limit any of the disclosure to the precise forms disclosed. It is contemplated that other alternatives or exemplary aspects that are considered included in the disclosure. The description is merely examples of embodiments, processes or methods of the disclosure. It is understood that any other modifications, substitutions, and/or additions can be made, which are within the intended spirit and scope of the disclosure. For the foregoing, it can be seen that the disclosure accomplishes at least all that is intended.

The previous detailed description is of a small number of embodiments for implementing the disclosure and is not intended to be limiting in scope. The following claims set forth a number of the embodiments of the disclosure with greater particularity.

1. A system for preventing loss of assets, the system comprising:
a computer adapted to receive, record, and update information related to a first investment account that is qualified to receive pre-tax contributions and is governed by tax rules related to required minimum distributions and is adapted to receive, record, and update information about a second investment account that is not qualified to receive pre-tax contributions;
wherein the computer is adapted to send an annual instruction causing an annual payment of at least a required minimum distribution amount to be made to an owner of the first investment account and to update an account balance of the first investment account to reflect a withdrawal of the annual payment amount;
wherein the computer is adapted to send an instruction to deposit a portion of the annual payment into the second investment account and to update an account balance of the second investment account to reflect a deposit of the portion of the annual amount; and
wherein the computer is adapted to annually determine a guaranteed minimum withdrawal amount that is equal to a largest required minimum distribution amount for any previous year and to send an instruction causing the annual payment to be equal to the guaranteed minimum withdrawal amount even if the guaranteed minimum withdrawal amount exceeds the account balance of the first investment account.

2. The system of claim 1, wherein the required minimum distribution amount is equal to a required minimum distribution as required by Internal Revenue Service regulations.

3. The system of claim 1, wherein the first investment account and the second investment account are established at the same time through a shared application process.

4. The system of claim 1, wherein the first investment account is associated with a qualified fixed annuity or qualified fixed index annuity.

5. The system of claim 4, wherein the second investment account is associated with a nonqualified fixed annuity or nonqualified fixed index annuity.

6. The system of claim 1, where the computer is further adapted to:
determine a legacy benefit amount; and
send an instruction causing a payment of the legacy benefit amount to a legacy beneficiary upon death of the owner of the first investment account.

7. The system of claim 1, wherein the computer is further adapted to:
calculate an incentive bonus associated with the second investment account, wherein the incentive bonus equals a percentage of the second investment account; and
send an instruction each year causing an amount equal to the incentive to be deposited into the non-tax-qualified annuity or investment if withdrawals are not taken from the second investment account during a preceding year.

8. The system of claim 1, wherein both the first investment account and the second investment account are operated by a single financial service provider.

9. The system of claim 1, wherein the first investment account and the second investment account have identical rates and surrender charges.

10. A method for preventing leakage of assets associated with required minimum distributions, the method comprising the steps of:
providing a computer adapted to manage annuity accounts, including a database with account information;
establishing a tax-qualified annuity account in the database on the computer;
establishing a non-tax-qualified annuity account in the database on the computer;
annually withdrawing a required minimum distribution from the tax-qualified annuity account, wherein the required minimum distribution is an amount required by Internal Revenue Service regulations;
automatically depositing a portion of the required minimum distribution into the non-tax-qualified annuity account; and
calculating a guaranteed minimum withdrawal that is equal to the largest required minimum distribution for any previous year, and withdrawing the guaranteed minimum withdrawal amount from the tax-qualified annuity account, even if the guaranteed minimum withdrawal amount exceeds a balance of the tax-qualified annuity account.

11. The method of claim 10, further comprising the steps of:
receiving an instruction from an owner of the non-tax qualified annuity account to deposit an amount less than the required minimum distribution to be deposited into the non-tax-qualified annuity account; and
depositing the amount less than the required minimum distribution into the non-tax-qualified annuity account.

12. The method of claim 10, further comprising the step of:
depositing a required minimum distribution associated with an asset other than the tax-qualified annuity account into the non-tax-qualified annuity account.

13. The method of claim 10, further comprising the step of:
determining each year whether withdrawals totaling less than a predetermined amount of withdrawal have made from the non-tax-qualified annuity account; and
automatically depositing an incentive bonus into the non-tax-qualified annuity account when less than a predetermined amount of withdrawal has made from the non-tax-qualified annuity account during the year.

14. The method of claim 10, wherein the tax-qualified annuity account and the non-tax-qualified annuity account are applied for and established simultaneously.

15. The method of claim 10, further comprising the steps of:
cancelling the non-tax-qualified annuity account; and
maintaining the tax-qualified annuity account.

16. The method of claim 10, further comprising the step of:
providing a consolidated financial statement including details from both the tax-qualified annuity account and the non-tax-qualified annuity account.
